(19) United States
(12) Patent Application Publication
(10) Pub. No.: US 2020/0232927 A1
(43) Pub. Date: Jul. 23, 2020

(54) SINGLE-USE ANALYSIS BOTTLE AND COLOR RESULTS MATCHING SYSTEM FOR COLORIMETRIC REAGENTS

(71) Applicant: Iain Peter William Fyfe, Applecross (AU)

(72) Inventor: Iain Peter William Fyfe, Applecross (AU)

(21) Appl. No.: 16/634,911

(22) PCT Filed: Jul. 28, 2018
(86) PCT No.: PCT/AU2018/050787

§ 371 Date: Jan. 29, 2020

Related U.S. Application Data
(60) Provisional application No. 62/538,645, filed on Jul. 29, 2017.

(30) Foreign Application Priority Data
Jul. 30, 2017 (AU) 2017902999

(51) Int. Cl. G01N 21/78; G01N 21/29; G01N 31/22; G01J 3/52

(52) U.S. Cl. CPC G01N 21/78; G01J 3/52; G01N 31/229; G01N 21/293

(57) ABSTRACT

Disclosed herein is a system for indicating via a colorimetric reaction the presence of a substance in a sample, comprising: a bottle containing a reagent and closable by a removable lid; and a label coupled to the bottle and comprising visual indicators for indicating the presence of a substance in a sample, wherein upon mixing the sample with the reagent in the bottle, the mixture changes to a particular color based on the identity of the substance in the sample, and each visual indicator is colored the color the mixture would be if a respective substance is in the sample, such that correspondence between the color of the mixture and the color of a visual indicator indicates the presence of the substance indicated by that visual indicator.

### TECHNICAL FIELD

The present invention generally relates to a single-use analysis bottle for colorimetric reagents, and to a color result matching system coupled to the bottle.

### BACKGROUND ART

Single-use strips and vials etc. are typically the most used rapid substance and/or impurity detection devices for identifying the presence of impurities in water, food, medicines and other substances in and outside of a laboratory environment. Colorimetric reagents are often used with such rapid substance/impurity detection devices. Traditionally, the accuracy of results produced from colorimetric testing and analysis depends on a user's testing method and experience. For example, a tester may be able to identify from a sample the presence of a substance and/or estimate the quantity of that substance based on the intensity and rapidity of a color reaction in a colorimetric analysis. A tester may also make such estimates by comparing the observed color with a color intensity chart, which is often hand-held, to identify a substance and/or a quantity thereof. Such substance identification and quantification are vulnerable to human error.

There are other drawbacks associated with existing rapid substance detection devices/methods. As outlined above, they do not provide a user-friendly means or interface for analysing or interpreting the results of a colorimetric test. Further, testers have to handle and manually measure out quantities of colorimetric reagents which are typically composed of hazardous substances. Moreover, in order to identify a substance and estimate a quantity thereof, testers are required to simultaneously observe the color change reaction, which is time-sensitive in nature, and a color intensity chart.

In such colorimetric tests, these hazardous colorimetric reagents are typically utilized in multiple panel reaction sequences to accurately identify a substance. As such, in order to produce the most accurate results, a tester is required to perform multiple tests with different colorimetric reagents in order to produce a higher coverage of comparative results. The accuracy of the results thus correlates with increasing health risks to the tester, due to the inherent risks associated with manual handling of hazardous substances in the form of the colorimetric reagents and potentially the samples being tested.

The above-mentioned multi-step sequences are employed to enhance selectivity for reagents results and therefore improve the accuracy of the outcome by decreasing the number of choices available for the tester when identifying the unknown substance. Therefore, more testing ensures better accuracy, however, more testing creates higher exposure for the tester to hazards.

Because color changes produced by colorimetric reactions need to be observed to ensure accuracy, environmental conditions which detract from a tester's ability to observe a color change can compromise a colorimetric analysis. As such, it is crucial that environmental conditions such as lighting are optimised and controlled to improve the tester's ability to observe any color changes and thus the accuracy of the test results.

Another problem associated with such rapid substance or impurity detection methods and devices relates to the storage of the sample for further analysis at different time intervals. Additionally, current methods and devices do not provide for the containing the colorimetric reaction as it occurs, nor the resulting mixture. Existing methods and devices also do not provide for recovery of the reacted reagent and sample solution since such solutions are typically hazardous and in a liquid form.

The present invention seeks to overcome or alleviate one or more difficulties of the prior art, or to at least provide a useful alternative.

### SUMMARY OF INVENTION

Embodiments of the present invention relate to a single-use analysis bottle and colour results matching system for colorimetric reagents to improve the accuracy of colorimetric detection using natural as well as the artificial light sources. Embodiments of the present invention also relate to a user-friendly and portable colour result matching system.

A first aspect of the invention provides a system for indicating via a colorimetric reaction the presence of a substance in a sample, comprising: a bottle containing a reagent and closable by a removable lid; and a label coupled to the bottle and comprising visual indicators for indicating the presence of a substance in a sample, wherein upon mixing the sample with the reagent in the bottle, the mixture changes to a particular color based on the identity of the substance in the sample, and each visual indicator is colored the color the mixture would be if a respective substance is in the sample, such that correspondence between the color of the mixture and the color of a visual indicator indicates the presence of the substance indicated by that visual indicator.

Preferably, the bottle is transparent; and at least a portion of the label is transparent such that the reaction and thus the color of the resulting mixture in the bottle can be directly observed through the label. This enables a tester to visually assess whether the color of the mixture matches the color of one of the visual indicators.

In embodiments of the invention, each visual indicator comprises a colored panel. For example, each panel can be printed onto the label.

In various embodiments of the invention, the lid includes indicating means for indicating an amount of the sample to be mixed with the reagent. The indicating means may comprise a visual perimeter provided on an upper surface of the lid, or a well into which an amount of the sample can be measured.

Preferably, the system comprises a light source for illuminating the mixture and/or the label. At the tester's discretion, this light source can either be natural or artificial light. A light source can help with the visual color assessment, particularly in darker environments. While the light source can be arranged to project light through a bottom of the bottle, it is considered that one or more light sources can also be used, and can project light through other portions of the bottle, such as its sidewall. The light source can be, but is not limited to: a torch; a flashlight; a laser; a lightbulb; a candle; or natural light.

In preferred embodiments of the invention, the label is formed from plastic and is adhered to a sidewall of the bottle.

A second aspect of the invention provides a method of identifying a substance in a sample using the system of the first aspect of the invention, comprising: removing the lid from the bottle; adding the sample into the bottle; closing the bottle with the lid; mixing the sample with the reagent to form a mixture; observing the color of the mixture after a predetermined period of time; and comparing the color of the mixture with one or more colors of the visual indicators.

The step of adding the sample into the bottle may comprise measuring out the amount of the sample based on the indicating means provided in or on the lid.

Additionally, if the color of the mixture does not correspond with the color of any of the visual indicators on the label, the method further comprises comparing the color of the mixture with colored visual indicators provided on a separate test result chart.

Accordingly, embodiments of the present invention provide a color result matching system coupled to a vessel such as a single-use analysis bottle.

Embodiments of the present invention provide a single-use analysis bottle for the identification and qualitative analysis of a substance present in a sample.

Embodiments of the present invention enable a tester to identify the substance or impurity present in the sample by observing the color change reaction generated inside the single-use analysis bottle and comparing the observed resulting color with the array of color result panels.

Embodiments of the present invention provide an efficient and user-friendly single-use analysis bottle.

### BRIEF DESCRIPTION OF DRAWINGS

Embodiments of the invention are further described, by way of example only, with reference to the accompanying drawings, in which:

FIG. 1 is front a schematic view of a color result matching system coupled to a single-use analysis bottle containing a colorimetric reagent, in accordance with embodiments of the present invention;

FIG. 2 is a top view of a lid configured to detachably attach to the single-use analysis bottle of FIG. 1;

FIG. 3 illustrates a side schematic diagram of the single-use analysis bottle of FIG. 1, the bottle being illuminated by a light source;

FIG. 4 illustrates a reagent test result chart; and

FIG. 5 is a flowchart of the steps involved with conducting a colorimetric analysis for identifying a substance in a sample using the single-use analysis bottle of embodiments of the present invention.

### DESCRIPTION OF EMBODIMENTS

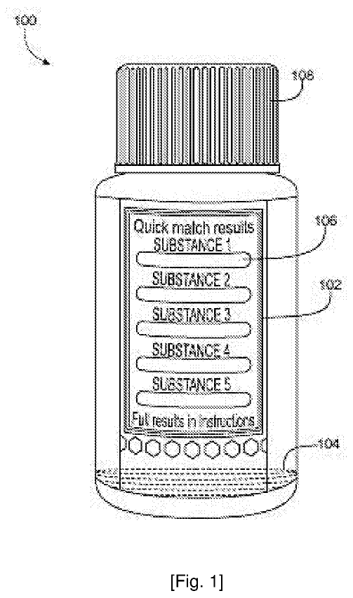

FIG. 1 shows a front schematic view of a colour result matching system 102 coupled to a transparent single-use analysis bottle 100 containing a colorimetric reagent 104. The color result matching system comprises a label 102 which is coupled to the bottle 100. In the depicted embodiment, the label 102 is adhered to the bottle 100 by wellknown means, such as glue. At least some portions of the label 102 are transparent such that a tester can see therethrough and into the bottle 100, allowing the tester to observe the reagent 104 and any color changes. In FIG. 1, the label 102 is provided with an array of colored panels 106, each panel 106 being of a different color and indicative of the presence of a respective substance. Of course, the number of panels 106 may vary and can be tailored so as to be indicative of a range of different substances, depending on which substances are to be tested for. The panels 106 need not take the shape or form of what is shown in FIG. 1; they could, for example, be in the form of colored circles. In preferred embodiments of the invention, the label 102 is made from a suitable plastic.

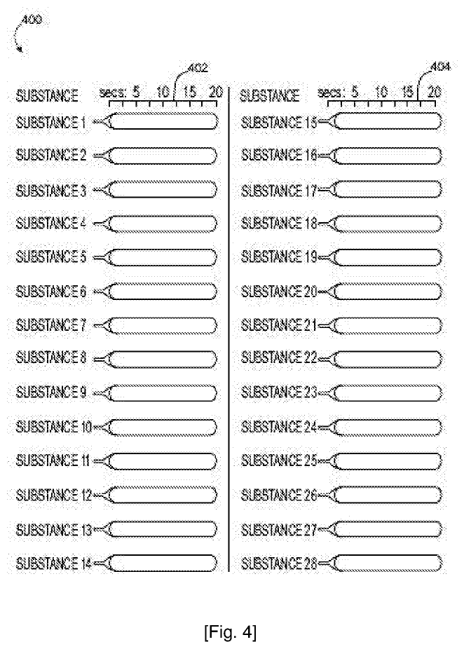

The colored panels 106 help the tester identify whether a particular substance is present in a sample. For example, suppose it is known that a particular substance X will react with the reagent 104 and cause the resulting solution to turn into color Y, and suppose that positive identification of X is desired. One of the colored panels 106 on the label 102 can be colored Y, and adjacent to the panel 106 can be displayed the name of substance X. After adding a sample into the bottle 100 and mixing it with the reagent 104, the tester can then compare the color of the resulting solution to the color of the colored label 102 corresponding to X. If the color of the solution matches the color of the label 102, then the tester can conclude that the sample contains substance X. If the solution does not turn into color Y and thus does not match the color of the label 102, the tester can conclude that the sample does not contain substance X. Of course, the other color panels 106 can be indicative of other substances, and the tester may find that the resulting color of the solution actually matches the color of one of those panels 106, in which case the tester can conclude that the sample contains the substance identified by that colored panel 106. Alternatively, if the resulting color of the solution does not correspond with the color of any one of the colored panels 106, the tester may refer to an accompanying reagent test result chart 400, as shown in FIG. 4, which provides a comprehensive list of substances and the corresponding color of the resulting solution should they be present in a tested sample.

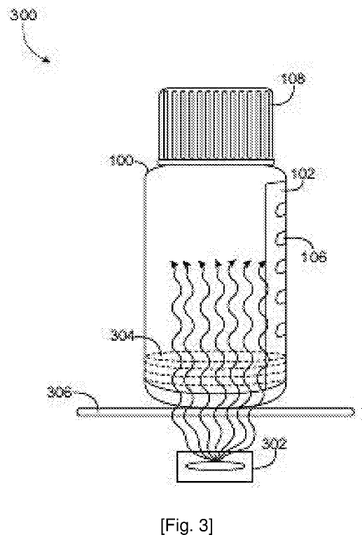

As shown in in FIG. 3, a light source 302 may be placed below the transparent bottle 100 to illuminate the solution and the colored panels 106. The light source 302 can include a torch, a flashlight, a laser, a lightbulb, a candle, natural light or the light from a smart phone.

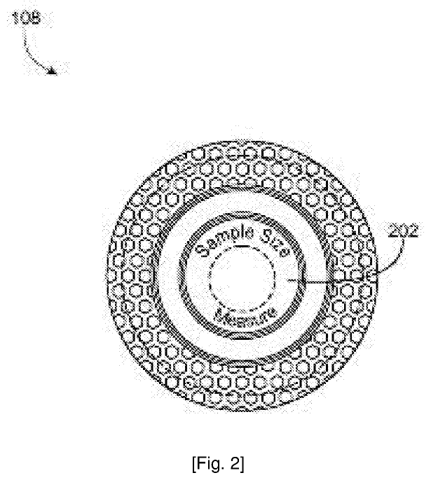

FIG. 2 shows a schematic diagram of a lid 108 configured to detachably attach to the single-use analysis bottle 100. The single-use analysis bottle 100 comprises an open top portion adapted to receive the lid 108. The lid 108 closes the open top portion, thereby sealing the bottle 100 closed. The lid 108 is made of a plastic material which is not chemically reactive with the sample, colorimetric reagent 104, or the resulting reacted solution.

With reference to FIG. 2, the lid 108 indicates to the tester the size of the sample that is suitable for addition into the bottle 100 for the colorimetric reaction. In the depicted embodiment, the indicator comprises a visual indicator in the form of a circular dotted line 202 that delimits the size of the sample required for the qualitative analysis thereof. The lid 108 may provide other ways of indicating an ideal sample size to the tester. For example, the lid 108 could include a concave groove or well into which a sample can be added in order to measure out a suitable volume thereof.

FIG. 3 shows a schematic side view 300 of the bottle 100 positioned above and illuminated by a light source 302. As depicted, the bottle 100 is placed on a flat surface 306 and over a cavity provided therein. The light source 302 is positioned beneath the flat surface 306 and emits a beam of light through the cavity and into the bottle 100, thereby allowing for the illumination of a reacted solution, as well as the array of color result panels 106. Illumination of the solution and the color panels 106 can facilitate the accurate observation of the color change and its comparison with the colored panels 106, particularly in dimly lit environments, such as a nightclub. The bottle 100 can also be illuminated simultaneously from other directions (e.g. with one or more light sources directed at the side of the bottle 100) for ease of color change observation and comparison.

FIG. 4 illustrates an example reagent test result chart 400, as previously discussed. A list of substances is provided alongside respective colored panels 106, each panel 106 being in the color of the resulting reacted solution if that respective substance is present in the sample added to the colorimetric reagent 104 in the bottle 100. As such, if a tester finds that the color of the resulting solution in the bottle 100 does not match one of the colored panels 106 provided on the label 102, the tester can compare the color of the solution with the colored panels 106 shown on the result chart 400. By matching the color of the reacted solution with a corresponding colored panel 106 on the result chart 400, the tester can conclude that the corresponding substance is present in the tested sample.

Examples of the substances or impurities that can be identified by embodiments of the present invention include MDMA (3,4-Methylenedioxymethamphetamine)/MDA/MDE, Amphetamine/Methamphetamine, 2C-B, 2C-1, 2C-E, 2C-T-2, 2C-T-4, 2C-T-7, MDVP/Methylone/Butylone, Mephedrone, Ketamine, Methoxetamine, LSD, Mescaline, PMA, PMMA, DXM, Codeine, Morphine, Oxycodone, Heroin, Cocaine, Ritalin, Aspirin, Sugar etc.

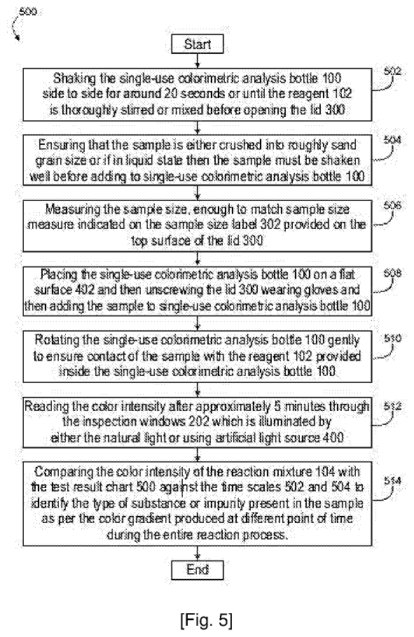

FIG. 5 illustrates a flowchart 500 of a method for conducting colorimetric analysis for identification of a substance in a sample using the single-use analysis bottle 100. The method initiates with a first step 502 of shaking the bottle 100 side to side for approximately 20 seconds or until the colorimetric reagent 104 is thoroughly stirred or mixed before opening the lid 108. A second step 504 includes ensuring that the sample is crushed into the size of grains of sand, or, if the sample is in a liquid state, ensuring the sample is shaken well, before adding it to the bottle 100. A third step 506 includes measuring the sample size to match the sample size indicated by the lid 108. A fourth step 508 includes placing the bottle 100 on a flat surface and removing the lid 108 while wearing safety gloves and then adding the sample into the bottle 100. The bottle 100 must remain open to allow the colorimetric reaction to take place under environmental conditions. A fifth step 510 of the method includes rotating the bottle 100 gently to ensure sufficient contact between the sample and the colorimetric reagent 104 provided inside the bottle 100. The sample will react with the colorimetric reagent 104 and, within the first 60 seconds of the reaction, the color intensity of the reaction mixture changes gradually.

A sixth step 512 of the method includes observing through the transparent bottle 100 the color intensity of the resulting sample and reagent 104 solution approximately 5 minutes after adding the sample into the bottle 100. A seventh step 514 of the method includes: (1) comparing the color of the resulting reacted solution with the colored panels 106 provided on the label 102 and determining that a particular substance is present in the sample if the color of the solution matches a particular color of a colored panel; or (2) comparing the color of the resulting reacted solution with the colored panels 106 provided on the test result chart and determining that a particular substance is present in the sample if the color of the solution matches a particular color of a panel 106 on the chart. Typically, all changes in color occur within the first 60 seconds of adding the sample to the reagent 104. The concentration of the substance or an impurity in the sample, and the amount of sample added, affects the rapidity of the colorimetric reaction. Generally, after 5 minutes of mixing the sample with the reagent 104, the colorimetric reaction is test is complete. Once the test is complete, the user should dispose of the bottle 100 along with the liquid in a safe manner.

It has been determined that the effectiveness or completeness of the colorimetric reaction is dependent on adding an amount of a sample into the bottle based on the dimensions of the bottle and the volume of the reagent therein. In this regard, it has been determined that the diameter of the bottle can be a significant consideration. In particular, the ratio of the cross-sectional area of the interior of the bottle to the volume of reagent is important.

In an example, the cross-section of the interior of the bottle is generally cylindrical with a total volume of 5000 μl, a hollow diameter of 21 mm, and thus a cross-sectional area of the interior of the bottle is 346.36 mm². The following parameters for specific reagents have been determined to facilitate the colorimetric reaction:

TABLE 1

| | Mandelin or | |
|---|---|---|
| | Marquis | Tryptamines |
| Effective fill | 350 μl | 500 μl |
| Ratio of interior diameter of bottle to | 0.06 | .042 |
| volume of reagent | | |
| Ratio of cross-sectional area of bottle | 0.9896 | 0.6927 |
| interior to fill volume | | |

If the geometry of the bottle changes, then the amount of reagent should also be adjusted to conform with the above effective ratios. This is shown in the following table:

TABLE 2

| | Mandelin or | |
|---|---|---|
| | Marquis | Tryptamines |
| Effective fill for bottle diameter | 372.67 μl | 532.38 μl |
| of 22.36 mm | | |
| Effective fill for bottle diameter | 833.33 μl | 1190.48 μl |
| of 50 mm | | |

Even if the above precise effective fill amounts and thus ratios cannot strictly be adhered to, a working range of reagent volume has been determined by reference to the geometry of the bottle. The below table illustrates a working range for a bottle interior diameter of 22.36 mm and a volume of 5000 μl:

TABLE 3

| | Minimum fill | Maximum fill of |
|---|---|---|
| | of 50 μl | 2000 μl |
| Ratio of diameter to fill volume | 0.4472 | 0.01118 |
| Ratio of cross-sectional area of | 7.854 | 0.19635 |
| bottle interior to fill volume | | |

Accordingly, if the geometry of the bottle differs from those specified above, the colorimetric reaction can still be facilitated by the addition of a reagent whose volume, relative to bottle geometry, falls within the above lower and upper limit ratios.

The amount of a substance to add into the bottle will also influence the completeness of the colorimetric reaction. The amount of substance added should be based on the cross-sectional area of the interior of the bottle. Below are two ways for determining a preferred amount of substance to add.

The first way is based on the ratio of the effective weight of the substance to the diameter of the bottle. If the inner diameter of the bottle is 22.36 mm, then the weight of the sample to be added into the bottle should range from 0.1 mg to 2500 mg, thereby providing a working weight to diameter ratio of 00.4472 to 111.81. Should the diameter of the bottle vary, the weight of the substance should also vary so as to stay within this working range.

The second way is based on the volume of the sample as a ratio of the inner diameter of the bottle, specifically, the volume of a half sphere clump of the sample. Assuming a bottle with an inner diameter of 22.36 mm, the maximum diameter of the clump is also 22.36 mm. Consequently, the maximum working volume of sample to diameter of bottle ratio is 130.89. Again, should the diameter of the bottle vary, the volume of the sample added into the bottle should vary to stay at or lower than this maximum working ratio.

Embodiments of the present invention provide an easy-to-use device and method for identifying the presence of one or more substances in a sample.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as, an acknowledgement or admission or any form of suggestion that that prior publication (or information derived from it) or known matter forms part of the common general knowledge in the field of endeavor to which this specification relates.

1. A system for indicating via a colorimetric reaction the presence of a substance in a sample, comprising:
a bottle containing a reagent and closable by a removable lid; and
a label coupled to the bottle and comprising visual indicators for indicating the presence of a substance in a sample,
wherein upon mixing the sample with the reagent in the bottle, the mixture changes to a particular color based on the identity of the substance in the sample, and each visual indicator is colored the color the mixture would be if a respective substance is in the sample, such that correspondence between the color of the mixture and the color of a visual indicator indicates the presence of the substance indicated by that indicator.

2. The system of claim 1, wherein: the bottle is transparent; and at least a portion of the label is transparent such that the reaction within the bottle, and the color of the resulting mixture in the bottle, can be observed through the label.

3. The system of claim 1, wherein each visual indicator comprises a colored panel.

4. The system of claim 1, wherein the lid includes indicating means for indicating an amount of the sample to be mixed with the reagent.

5. The system of claim 4, wherein the indicating means comprises a visual perimeter provided on an upper surface of the lid.

6. The system of claim 4, wherein the indicating means comprises a well via which an amount of the sample can be measured out.

7. The system of claim 1, further comprising a light source for illuminating the mixture and/or the label.

8. The system of claim 7, wherein the light source is arranged to project light through a bottom and/or side of the bottle.

9. The system of claim 7, wherein the light source comprises any one of: a torch; a flashlight; a laser; a lightbulb; a candle; or natural light.

10. The system of claim 1, wherein the label is formed from plastic and is adhered to a sidewall of the bottle.

11. A method of identifying a substance in a sample using the system of any one of the preceding claims, comprising:
observing the color of the reagent;
removing the lid from the bottle;
adding the sample into the bottle;
closing the bottle with the lid;
mixing the sample with the reagent to form a mixture;
observing the color of the mixture after a predetermined period of time; and
comparing the color of the mixture with one or more colors of the visual indicators.

12. The method of claim 11, wherein observing the color of the mixture includes observing the color of the mixture during the colorimetric reaction.

13. The method of claim 11, wherein the step of adding the sample into the bottle comprises measuring out the amount of the sample based on the indicating means.

14. The method of claim 11, wherein if the color of the mixture does not correspond with the colors of any of the visual indicators, the method further comprises comparing the color of the mixture with colored visual indicators provided on a separate test result chart.
